(19) United States
(12) Patent Application Publication
(10) Pub. No.: US 2014/0040026 A1
(43) Pub. Date: Feb. 6, 2014

(54) SYSTEMS AND METHODS FOR INCLUDING ADVERTISEMENTS IN STREAMING CONTENT

(71) Applicants: Viswanathan Swaminathan, Saratoga, CA (US); Venkat Jonnadula, Mountain View, CA (US); Kelly Kishore, Belmont, CA (US)

(72) Inventors: Viswanathan Swaminathan, Saratoga, CA (US); Venkat Jonnadula, Mountain View, CA (US); Kelly Kishore, Belmont, CA (US)

(73) Assignee: Adobe Systems Incorporated, San Jose, CA (US)

(21) Appl. No.: 13/464,819

(22) Filed: May 4, 2012

(51) Int. Cl. G06Q 30/02

(52) U.S. Cl. 705/14.53; 705/14.66; 705/14.58

(57) ABSTRACT

Various embodiments in this disclosure describe a method and a system for including advertisements in streaming content. For example, a manifest file may be accessed by a client device from a server device via a network, the manifest file including one or more media segment URLs and one or more advertisement markers arranged in a predetermined sequence. The advertisement markers included in the manifest file may be replaced by the client device with advertisement URLs associated with user-customized advertisements. The media segment URLs and the advertisement URLs included in the manifest file may then be sequentially accessed in accordance with the predetermined sequence.

This patent document pertains generally to electronic content, and more particularly, but not by way of limitation, to systems and methods for including advertisements in streaming content.

### BACKGROUND

The practice of streaming video content from online sources onto user devices (such as personal computers, mobile devices, smartphones, tablet computing devices, etc.) is becoming increasingly popular. In order to stream video content in accordance with various HTTP streaming schemes, a user device generally accesses a manifest file (also known as an index file or a playlist file) from a remote web server, where the manifest file includes a sequential list of implicit or explicit reference links (e.g. Uniform Resource Locator or “URL” links) to media segment files containing sequential portions of the video content to be streamed. The client device then accesses each of the media segment files in order to stream the video content.

### BRIEF DESCRIPTION OF THE DRAWINGS

Some embodiments are illustrated by way of example and not limitation in the figures of the accompanying drawings in which:

FIG. 1 is a network diagram depicting a client-server system, within which various exemplary embodiments may be deployed;

FIG. 2 is a block diagram of an example system, according to various embodiments;

FIGS. 3 and 4 illustrate examples of manifest files;

FIG. 5 is a schematic diagram of an exemplary data flow, according to various embodiments;

FIG. 6 is a flowchart illustrating an example method, according to various embodiments;

FIGS. 7a and 7b are a flowchart illustrating an example method, according to various embodiments;

FIGS. 8a through 8f illustrate examples of manifest files;

FIGS. 9a and 9b are a flowchart illustrating an example method, according to various embodiments;

FIGS. 10a and 10b are a flowchart illustrating an example method, according to various embodiments.

FIGS. 11a and 11b illustrate examples of manifest files;

FIG. 12 is a flowchart, illustrating an example method, according to various embodiments;

FIG. 13 is a flowchart illustrating an example method, according to various embodiments; and

FIG. 14 is a block diagram of machine in the example form of a computer system within which a set instructions, for causing the machine to perform any one or more of the methodologies discussed herein, may be executed.

### DETAILED DESCRIPTION

Example methods and systems for including advertisements in streaming content are described. In the following description, for purposes of explanation, numerous specific details are set forth in order to provide a thorough understanding of example embodiments. It will be evident, however, to one skilled in the art that the present embodiments may be practiced without these specific details.

As described in the example embodiments of this disclosure, a client device may stream video content from online sources, while also interleaving user-customized advertisements (“ads”) into the video content, in order to provide a continuous stream of content to the user. For example, a manifest file (also known as an index file or a playlist file) for streaming particular video content may be accessed by the client device from a server device via a network, the manifest file including one or more media segment URLs and one or more advertisement markers arranged in a predetermined sequence. The aforementioned media segment URLs are links for accessing media segment files containing sequential portions of the video content to be streamed, where the client device is configured to sequentially access each of the media segment files (via the media segment URLs), in order to playback the sequential portions of the video content.

According to various embodiments, the client device obtains user-customized ads that are customized for the particular user of the client device. For example, the client device may transmit user preference information (which may include geo-location information) to an advertisement network server that analyzes the user preference information in order to determine particular user-customized ads, and transmits URLs for accessing these advertisements to the client device. Thereafter, the client device may replace the advertisement markers included in the manifest file with the advertisement URLs associated with the user-customized advertisements. The manifest file may then be provided to a media playback application or module that “plays” the content, by sequentially accessing the media segment URLs and the advertisement URLs included in the manifest file. Thus, a continuous stream of content—including video content as well as seamlessly integrated user-customized ads—are presented to the user.

Moreover, it may be helpful to customize one or more of the advertisements (e.g., make the decision of which advertisement network to contact and/or which advertisements to present) as late as possible prior to playback of the advertisements, during the streaming playback of the video content. Thus, according to various exemplary embodiments of this disclosure, one or more of the advertisements will be customized for the user at the client-side after the manifest file is accessed from the server device. Moreover, various embodiments described below include various aspects of obtaining the user-customized advertisements and inserting them into the manifest file as late as possible, during the streaming playback of the video content.

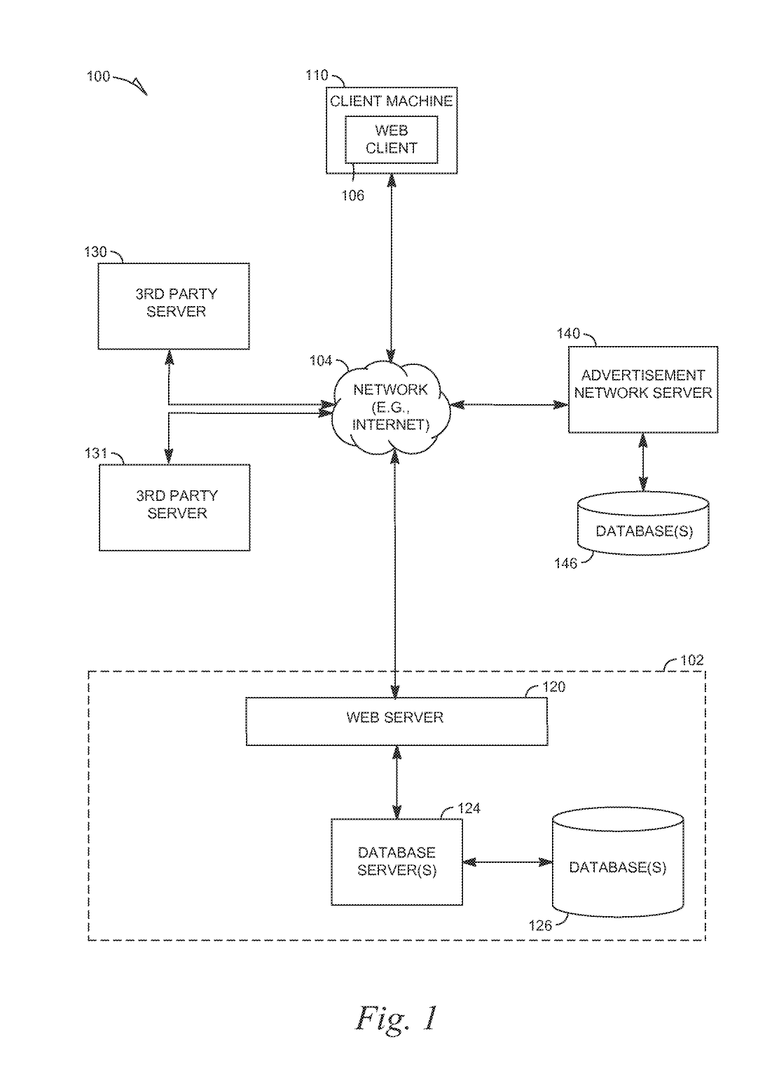

Turning now to FIG. 1, there is illustrated a network diagram depicting a client-server system 100, within which one or more example embodiments may be deployed. A networked system 102, in the example form of a network-based streaming content playback system, provides server-side functionality, via a network 104 (e.g., the Internet or Wide Area Network (WAN)) to one or more clients. The networked system 102 includes a web server 120. FIG. 1 illustrates, tier example, a web client 106 (e.g., a browser) executing on a client machine 110. The web server 120 is, in turn, shown to be coupled to one or more database servers 124 that facilitate access to one or more databases 126.

Further, while the system 100 shown in FIG. 1 employs a client-server architecture, the present embodiments are of course not limited to such an architecture, and could be implemented in a distributed, or peer-to-peer, architecture, for example. The various modules of the client machine 110 discussed below could also be implemented as standalone software programs, which do not necessarily have networking capabilities.

FIG. 1 also illustrates third party server machines 130 and 131 connected to the client machine 110 via a network 104. Third party server machines 130 and 131 may, for example, host media segment files of content, or host advertisements, as described in more detail below. Moreover, FIG. 1 also illustrates an advertisement (“ad”) network server 140 connected to the client machine 110 via network 104. The advertisement network server 140 is, in turn, shown to be coupled to one or more databases 146.

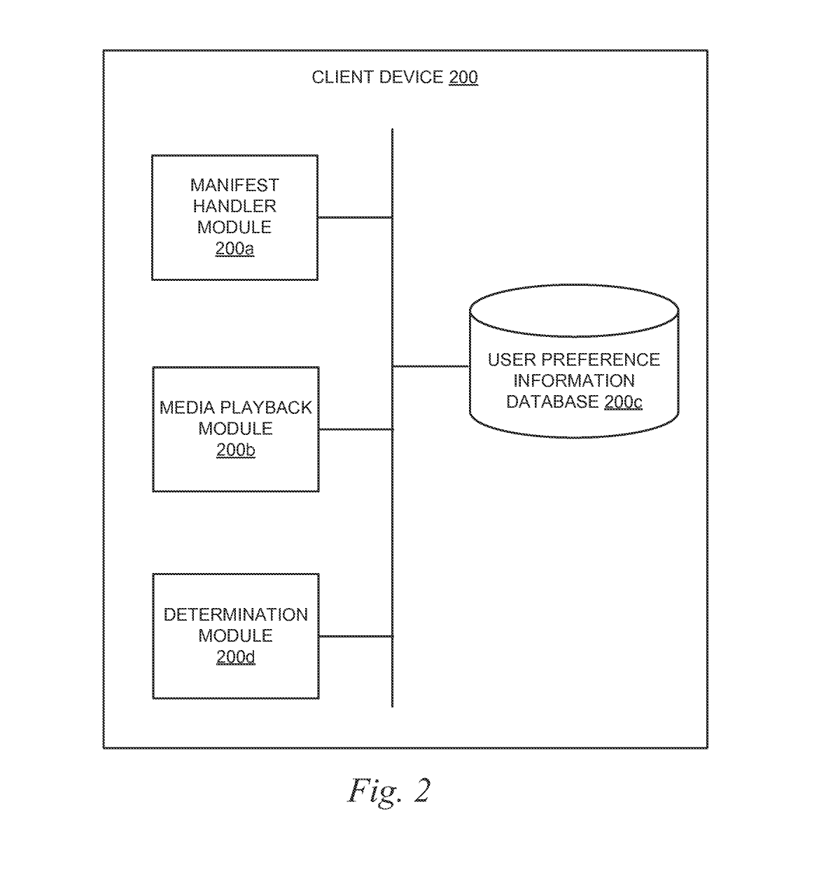

Turning now to FIG. 2, there is illustrated a client device according to various exemplary embodiments. The client device 200 may be implemented in, for example, client machine 110 illustrated in FIG. 1. The client device 200 may include a manifest handler module 200a, a media playback module 200b, a user preference information database 200c, and a determination module 200d.

The manifest handler module 200a is configured to access a manifest file from a server device (e.g. web server 120) via a network (e.g. network 104). For example, the manifest file may be stored at a specific address identified via a reference link (such as a Uniform Resource Locator (URL)), and the manifest handler module 200a may transmit an HTTP request tier the manifest file to the server device by accessing the reference link. In turn, the server device may transmit the manifest file back to the client device 200 via the network 104. Thus, the manifest files may be obtained by the manifest handler module 200a using one or more pull-type communication requests.

The manifest file may include one or more media segment reference links and one or more advertisement markers arranged in a predetermined sequence. The media segment reference links are reference links that point to (and may be used for accessing) segments of media content, such as media segment files. A media segment reference link may be, for example, a Uniform Resource Identifier (URI), Uniform Resource Locator (URL), Uniform Resource name (URN), or some other type of reference link. According to a preferred embodiment, the media segment reference links correspond to URLs (referred to throughout this disclosure as “media segment URLs”, in the interests of clarity and brevity). However, it should be understood that the aspects of this disclosure are applicable to all types of media segment reference links, and are not limited to URL-type media segment reference links.

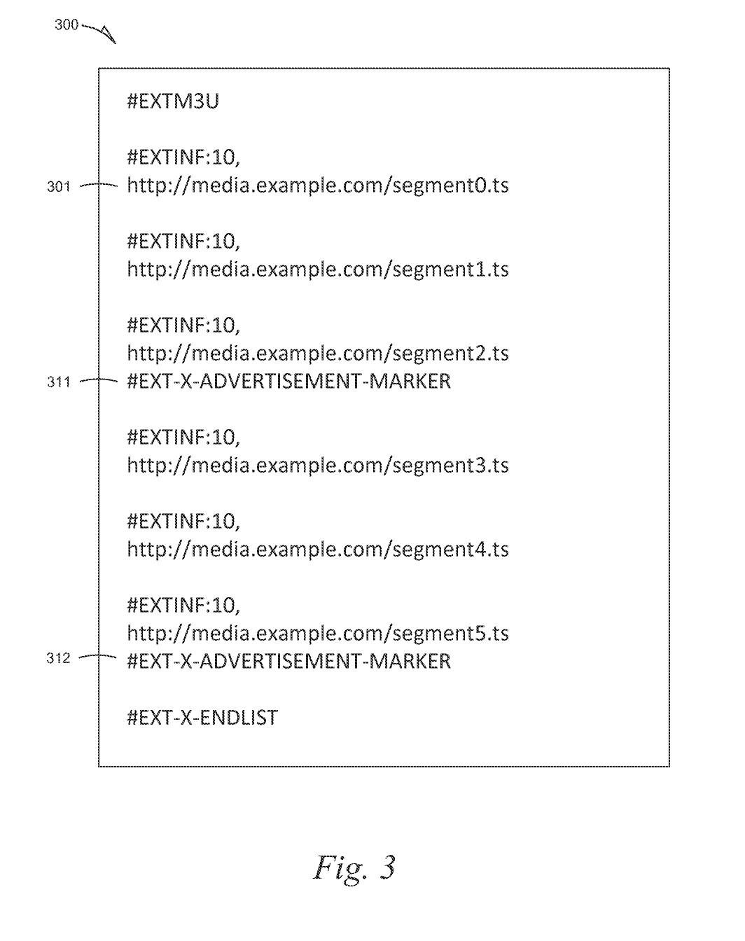

FIG. 3 illustrates an example of a manifest file 300 associated with streaming video content obtained from a server device. The manifest file 300 includes six media segment URLs (e.g. media segment URL 301), arranged in a specific order, for accessing sequential media segment files corresponding to sequential portions of the video content via a network 104. For example, each of the various media segment files may be located and stored on third party servers (e.g. third party servers 130, 131 in FIG. 1), web servers (e.g. web server 120 illustrated in FIG. 1), or various other devices connected to the client device 200 via one or more networks, and may be fetched to the client device 200 for playback. It is possible that the media segment files may also be located and stored on the client device 200.

The manifest file 300 further includes one or more advertisement markers (e.g. advertisement markers 311 and 312) that signify the positions where advertisement reference links for user-customized advertisements may be inserted into the manifest file. The advertisement reference links are reference links that point to (and may be used for accessing) advertisement content, such as advertisement segment files. An advertisement reference link may be, for example, a Uniform Resource Identifier (URI), Uniform Resource Locator (URL), Uniform Resource name (URN), or some other type of reference link. According to a preferred embodiment, the advertisement reference links correspond to URLs (referred to throughout this disclosure as “advertisement URLs”, in the interests of clarity and brevity). However, it should be understood that the aspects of this disclosure are applicable to all types of advertisement reference links, and are not limited to URL-type advertisement reference links.

Together, the one or more media segment URLs and advertisement markers in the manifest file are arranged in a predetermined sequence. As seen in FIG. 3, the advertisement markers may be inserted into the manifest file 300 as metadata (e.g. inserted after the “#.” tags) associated with the various media segment URLs. While various embodiments of this disclosure (e.g. the exemplary manifest file 300 illustrated in FIG. 3) include advertisement markers taking the exemplary form of “#EXT-X-ADVERTISEMENT-MARKER”, it should be understood that any form of marker or indicia (e.g. any character string, any alpha-numeric string, etc.) may be utilized to signify the position where the advertisement URLs may be inserted into the manifest file. The manifest handler module 200a is configured to inspect the manifest file for the aforementioned advertisement markers, and obtain user-customized ads for insertion into the manifest file 300 at the advertisement markers. The manifest handler module 200a may obtain the user-customized ads in a number of ways.

For example, the client device 200 may store user preference information in user preference information database 200c. The user preference information may include metadata and keywords describing various preferences, interests, etc. of the user. The determination module 200d of the client device 200 may collect such keywords and metadata based on various user input, and store it in the user preference information database 200c. Such user input includes personal user information, user internet search history, user internet browser history (e.g., cookies, caches, etc.), user responses to questionnaires or surveys, analysis of user profile information on social networking website, and so on. The determination module 200d of the client device 200 may determine or receive a determination of the preferences or interests of the user, based on the aforementioned information. For example, systems exist for analyzing social media profile information of users in order to determine metadata and keywords indicating areas of interest for users (using keyword, analysis, sentiment analysis, “taste graphs” and so forth) in order to target online advertisements towards users. These systems may be utilized by the determination module to determine the preferences and interests of the user, as represented by keywords and metadata, which may be stored in the user preference information database 200c. It should be understood that the user preference information may be collected and stored remotely at a remote server accessible via a network.

The client device 200 may also obtain goo-location information indicating the current location of the client device, via GPS locator, or signal strength of nearby cellular network towers, etc., as understood by those skilled in the art. For convenience, the user preference information described herein is considered to include such geo-location information. The client device 200 may also obtain content information indicating metadata and keywords regarding the actual content to be streamed. Such metadata may be included in the manifest file, or received from the web server or a third party server via the network. For convenience, the user preference information described herein is considered to include such content information.

The manifest handler module 200a may then transmit the user preference information to an advertisement network server of an advertisement network, such as advertisement network server 140 illustrated in FIG. 1. The advertisement network server 140 may analyze the metadata, keywords, etc. of the user preference information and determine one or more advertisements that are customized to the interests and preferences of the user. For example, database 146 may store a list of advertisements associated with various candidate user preference information, candidate keywords, candidate metadata, etc. The advertisement network server 140 may also communicate with other devices via a network, such as one or more other advertisement network servers, in order to determine the one or more advertisements that are customized of the user. The advertisement network server 140 then transmits addresses or URLs for accessing the determined user-customized advertisements to the manifest handler module 200a of the client device 200. For example, each of the various advertisement files accessed via the advertisement URLs may be located on the client device, or on other client devices, or on 3^{rd} party servers (e.g. third party servers 130, 131 in FIG. 1), or on web servers (e.g. web server 120 in 1), etc.

According to various exemplary embodiments, the determination module 200d may itself determine, based on the user preference information, one or more advertisement networks to contact. For example, the client device may include a database storing a list of one or more advertisement networks, and metadata keywords corresponding to each of the advertisement networks. Thus, if the user preference information includes the metadata “teenager”, and “rock music” and the geo-location information “Los Angeles, Calif.”, the determination module 200d may determine that it is appropriate to contact a first advertisement network, whereas if the user preference information includes the metadata or “female”, “retired”, “pension” and the geo-location information “Fort Lauderdale, Fla.”, the determination module 200d may determine that it is appropriate to contact a second advertisement network. The manifest handler module 200a may communicate with advertisement network server corresponding to the determined advertisement network (such as advertisement network server 140 illustrated in FIG. 1). The one or more advertisement networks determine user-customized ads, as described above, and transmit URLs for accessing the ads to the manifest handler module 200a of the client device 200.

The advertisement networks may also determine the appropriate ads based on other factors, such as advertisement playback history information, or advertising targets and quotas. For example, suppose a particular customer of the advertisement network has requested that an ad be displayed X times. When the client device 200 transmits the user preference information, it may also submit a request for the advertisement URLs, as well as indication of how many advertisement markers need to be replaced, as well as what and how many advertisement URLs have already been received from the advertisement network and have been played by the media playback module 200b (i.e. advertisement playback history information). Accordingly, the advertisement network server may determine the appropriate ads for the client based on this information and the appropriate advertising targets and quotas to be reached. For example, the advertisement network may determine that a particular ad has not been displayed enough times to meet the advertising targets, and has never been displayed on a particular client device, so that ad will be sent to the client device 200. As another example, the advertisement network may determine that a particular ad has not been displayed enough times to meet the advertising targets, but it has been displayed many times on a particular client device 200 (perhaps diluting the effectiveness of the ad), on that ad will not be sent to the client device 200. As another example, the advertisement network may determine that a particular ad has been displayed enough times to meet the advertising targets, so that ad will not be sent to the client device

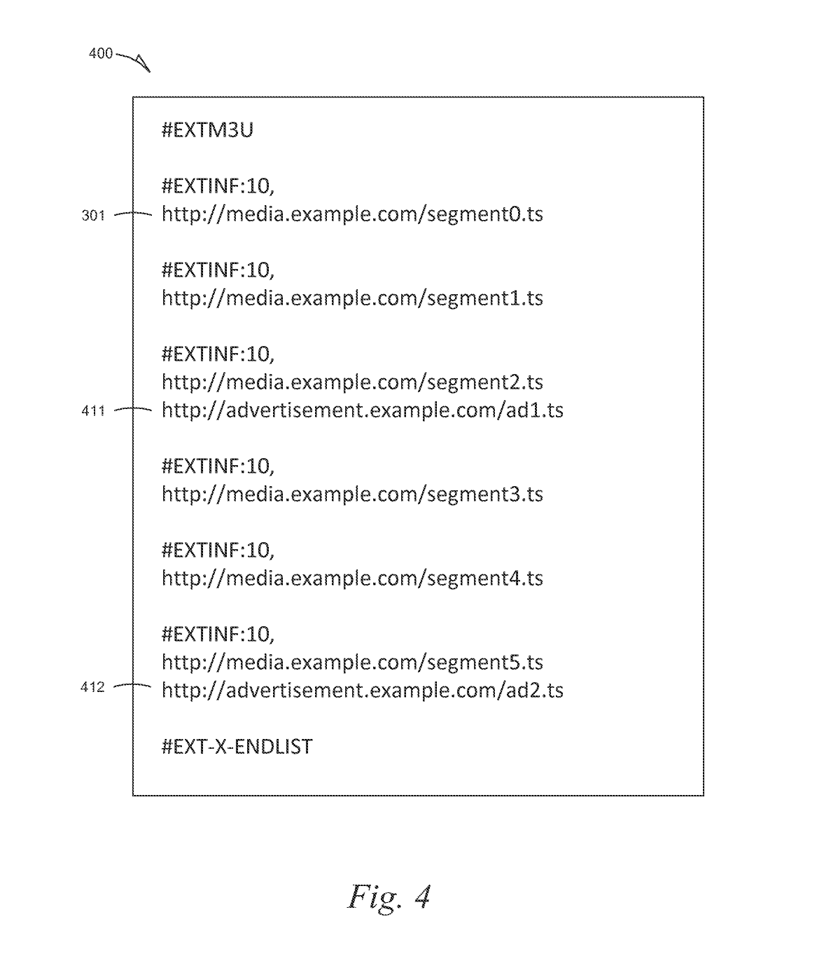

After the manifest handler module 200a illustrated in FIG. 2 determines or obtains the one or more advertisement URLs associated with user-customized advertisements, the manifest handler module 200a replaces the advertisement markers included in the manifest file with the advertisement URLs. FIG. 4 illustrates an example of a manifest file 400 similar to manifest file 300 illustrated in FIG. 3, where the advertisement markers (e.g. advertisement markers 311, 312 in FIG. 3) have been replaced with advertisement URLs for user customized ads (e.g. advertisement URLSs 411, 412 in FIG. 4). Together, the one or more media segment URLs 301 and advertisement markers are arranged in a predetermined sequence.

The manifest handler module 200a then provides the modified manifest file to the media playback module 200b. The media playback module 200b may be any application for streaming video content that is configured to receive a manifest file, and sequentially access a list of URLs included in the manifest file in order to playback video content. Thus, since the modified manifest file (e.g. manifest file 400) includes one or more media segment URLs and one or more advertisement URLs arranged in a predetermined sequence, the media playback module 200b sequentially access the media segment URLs and the advertisement URLs included in the modified manifest file in accordance with the predetermined sequence, to thereby display a continuous content stream including the user-customized advertisements. Thus, according to various exemplary embodiments, there is described a novel method for individualizing advertisements for video playback on various client devices e.g. personal computers, workstations, terminals, mobile devices, etc.). It should be understood that, while the manifest handler module 200a and media playback module 200b may be included in the same client device (e.g. device 200 illustrated in FIG. 2), they may instead be on separate network-connected devices.

Various embodiments of this disclosure may refer to a manifest file including one or more URL links to media segment files that may be explicitly defined within the manifest file. However, the aspects of this disclosure are applicable to manifest files that include implicit references (instead of—or in addition to—explicit references) to media segment files. Thus, the various techniques described in this disclosure are applicable to all HTTP streaming schemes, since some HTTP streaming schemes utilize manifest files where the media segment URLs are defined explicitly, while other HTTP streaming schemes allow the media segment file references in the manifest file to be defined implicitly.

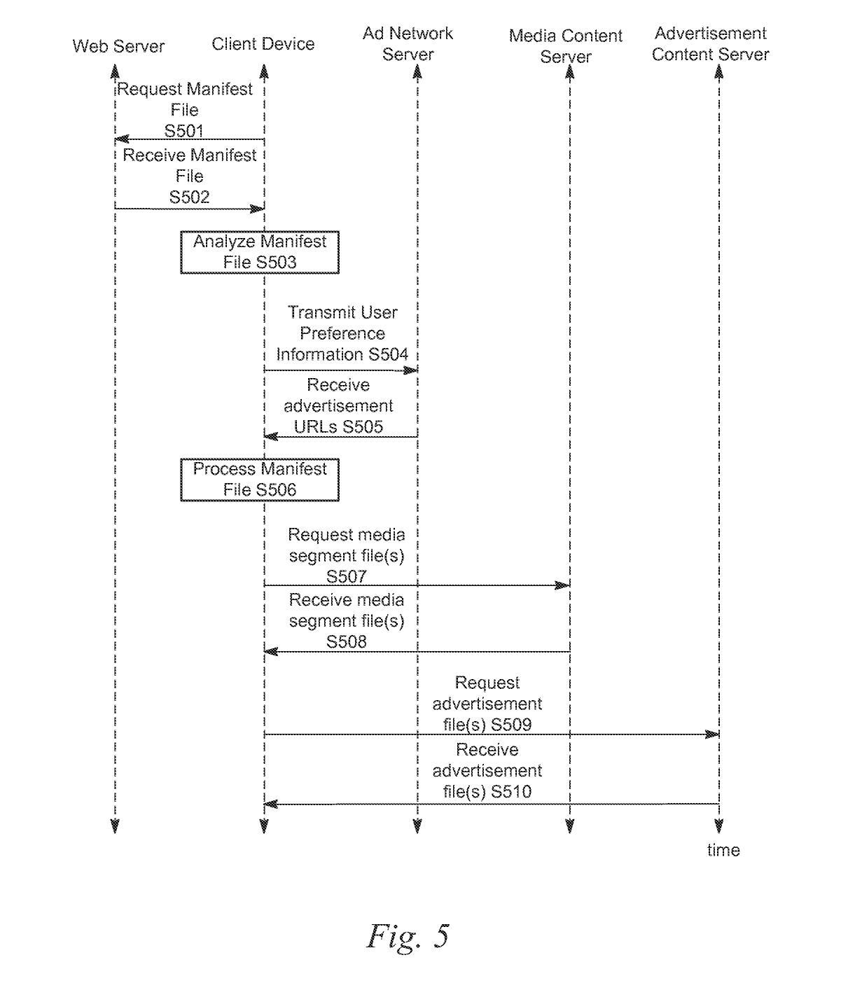

Turning to FIG. 5, a schematic diagram illustrating a dataflow in a system (such as system 100 illustrated in FIG. 1), in accordance with various exemplary embodiments, is presented. In S501, the client device requests access to a manifest file from a web server (e.g. by transmitting to the web server an HTTP request to a specified URL corresponding to the manifest file), and in S502 the client receives a response from the web server including the requested manifest file. In S503, the client performs various analysis of the manifest file, such as determining whether there are any advertisement markers included in the manifest file and, if so, how many are included.

Thereafter, in S504 the client device transmits user preference information to an advertisement network server and/or a request for a particular amount of advertisement URLs for accessing user-customized advertisements. (The client device may choose a specific advertisement network server to transmit the user preference information to, based on the contents of the user preference information). In response, the client device receives advertisement URLs for accessing user-customized ads to the client device in S505. The number of advertisement URLs may correspond to the number of advertisement markers, for example. In S506, the client device performs various processing on the manifest file, including replacing the advertisement markers in the manifest file with the advertisement URLs received in S505. Thereafter, the client device streams the video content based on the manifest file. For example, in S507, the client device accesses one or more media segment URLs included in the manifest file to request the corresponding media segment files, and receives these files in S508. Similarly, in S509 the client device accesses one or more advertisement URLs included in the manifest file to request the corresponding advertisement files, and receives these files in S510.

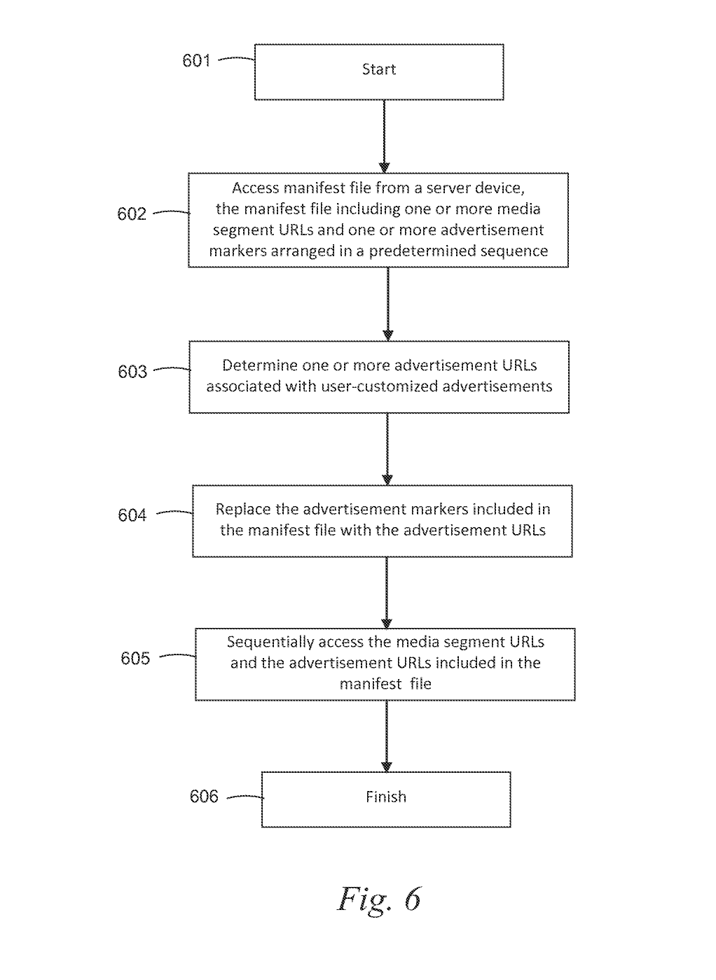

In FIG. 6, there is illustrated an exemplary method performed by a client device, in accordance with various exemplary embodiments. For example, the method of FIG. 6 may be performed by client device 200 illustrated in FIG. 2.

The method starts in step 601, and in step 602, the client device accesses a manifest file from a server device via a network, the manifest file including one or more media segment URLs and one or more advertisement markers arranged in a predetermined sequence. In step 603, the client device obtains or determines one or more advertisement URLs associated with user-customized advertisements, based on user preference information stored at the client device. In step 604, the client replaces the advertisement markers included in the manifest file with the advertisement URLs. In step 605, the client sequentially accesses the media segment URLs and the advertisement URLs included in the manifest file in accordance with the predetermined sequence, to thereby displaying a continuous content stream including the user-customized advertisements. The method finishes at step 606.

According to the various embodiments described in this disclosure, the manifest handler module may correspond to a specialized handler function for an application defined protocol (e.g. URL type, such as abcd://) in one or more client applications operating on a client device. This handler function may be triggered by specifying the URL for the manifest file to be of the URL type corresponding to the application defined protocol (e.g. abcd://manifest.m3u8). That is, a media playback application of the client (e.g. media playback module 200b in FIG. 2) may be given the URL of the manifest file with the http:// replaced with an application defined protocol type in the URL (e.g. abcd:// . . . ). The media playback application registers the application defined URL handler for the URI, type of interest (e.g. abcd:// . . . ), and the handler function is triggered for loading the manifest file. Thus, when a media playback application of the client transmits a request for a manifest file to the application defined protocol (e.g. abcd://manifest.m3u8) in an attempt to stream video content, the specialized handler function of the application defined protocol intercepts and traps the request for the manifest file. The handler in turn requests the manifest file from the server by simply changing the abcd:// to http://. After the handler performs the operations described in the various embodiments of this disclosure, the manifest file is provided to the media playback application, which plays back the media interleaved with the late bound advertisements. Thus, while various exemplary embodiments of this disclosure refer to a manifest handler module that requests a manifest file from a web server, it should be understood that the request for the manifest file may in fact originate from the media playback module. The request may be intercepted by the manifest handler module and transmitted to a web server, such that the manifest file may be received by the manifest handler module from the web server.

Thus, according to various exemplary embodiments, there is described a novel method for individualizing advertisements for video playback on various client devices (e.g. personal computers, workstations, terminals, mobile devices, etc.). The embodiments of this disclosure are applicable to various HTTP streaming schemes, including Adobe's ups (HTTP Dynamic Streaming), Apple's HTTP Live Streaming (HLS), and Microsoft's Smooth Streaming, which are becoming prevalent for delivering video to clients (and particularly mobile clients, where in some cases HTTP Streaming is the only option). The embodiments may be used for individualizing advertisements for video playback on devices utilizing iOS®, a mobile operating system offered by Apple, Inc, where the only realistic way of playing back streamed video is using the HTTP Live Streaming (HLS) protocol provided by Apple, Inc. The embodiments of this disclosure are not specific to iOS devices and can be used in applications running on other platforms too.

In this protocol, the device fetches a manifest file which contains a list of media segments for playback. The client fetches the media segments sequentially and plays back video as if the media segments were one long stream, which is a relatively easy and cost effective way to publish video. Using the HTTP protocol enables hosting the media segments on standard web servers while also leveraging the myriad available web caches and content distribution networks (CDNs). However, streaming using the conventional HLS protocol makes serving different advertisements to different users (devices) for the same content difficult, since the only place to specify the ad URLs is in the manifest file, but generating a different manifest file for each client is too expensive and cumbersome. That is, in case of HTTP streaming, given that the server delivers the same manifest file to all clients and both the advertisements and the media segments may be cached on servers, it is difficult to individualize the manifest file without making the server complex.

In contrast, in the embodiments described herein, the manifest file may be delivered through an application defined protocol URL to a media playback application. Application defined protocol requests are fetched by a handler function registered for that protocol. This handler function is invoked every time the media playback application requests the manifest file with the application defined protocol URL. As described below, this is invoked once for video on demand content and multiple times automatically for live and linear content as new media segments are added to the manifest file as they are available. When invoked, the handler function in turn fetches the manifest file from the server with in place (discontinuity) markers for advertisements. At this time, the handler also fetches the advertisements URLs from the appropriate advertisement networks of choice. The handler inserts the advertisement URLs into the manifest files spoofing it as a single seamless content to the device. As described below, even for VOD content, multiple content requests and in turn ad individualization can be effected simply by marking the content as type “Live”. This makes the client request the manifest file multiple times.

The video content that the user desires to stream generally corresponds to either pre-recorded content (also known as video-on-demand or VOD content) or live content. With VOD content, the manifest file will generally already include all of the media segment URLs for the entire video. The method illustrated in FIG. 6, for example, is applicable to streaming VOD content. On the other hand, with live content, the manifest file may be continuously updated at the server-side with new media segment URLs corresponding to new media segment files for the most recent live content, as that new live content is being recorded and stored in new media segment files.

According to various exemplary embodiments described below, the client device may access the manifest file for live content multiple times during a live event, as the manifest file is being updated at the web server side. According to an aspect of this disclosure, the method of FIG. 6 may be repeatedly performed by the client device each time the manifest file is downloaded. According to an aspect of this disclosure, each time the client accesses the manifest file including new media URLs and/or new advertisement markers, the client device obtains new user-customized advertisement URLs to replace any advertisement markers in the manifest file (or to replace any newly presented advertisement markers that have not been previously replaced with ad URLs). Thus, since the customized ads to be interleaved into the most recent portions of live video content are obtained only after the URLs to access the corresponding portions are downloaded, and just before the corresponding portions are played, the ads are customized for the user as late as possible during playback. Thus, the ads are better customized for the user, since they are selected based on the most recent information regarding user preferences, device geo-location, advertisement playback history, advertising targets, etc.

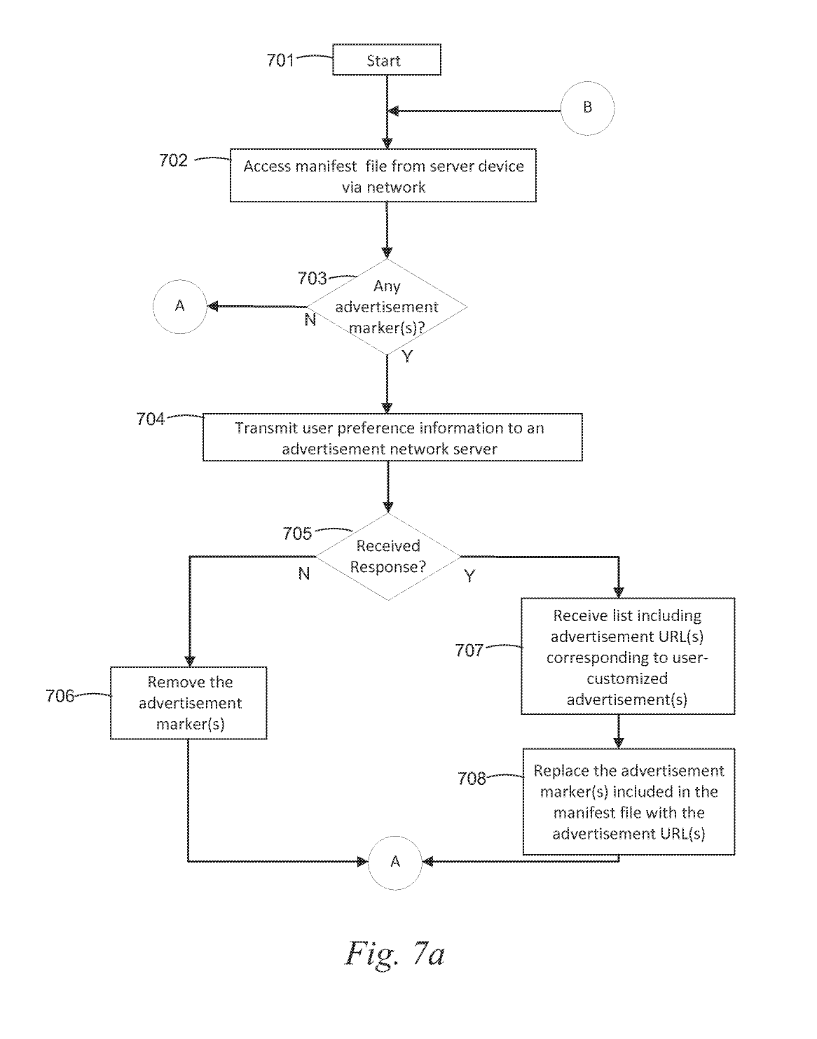

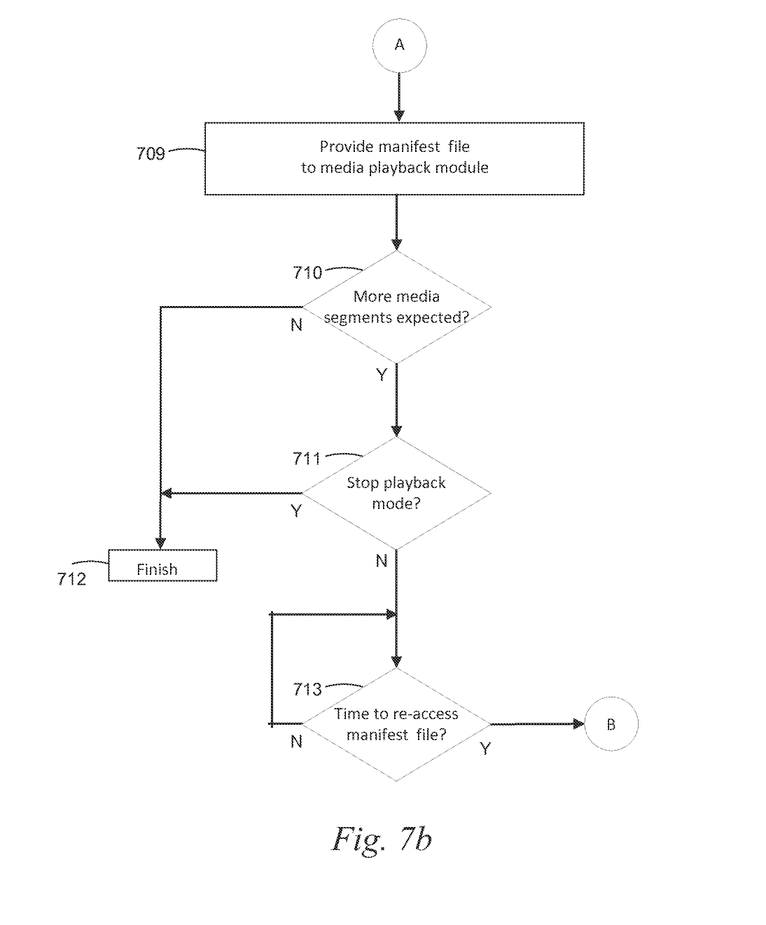

Various exemplary embodiments are described below with reference to 7a, 7b and 8a through 8f. In FIGS. 7a and 7b, there is illustrated an exemplary method of streaming live video content, performed by a client device, in accordance with various exemplary embodiments. The method of FIGS. 7a and 7b may be performed, for example, by an application handler such as manifest handler module 200a illustrated in FIG. 2).

The method starts in step 701, and in step 702, the handler accesses a manifest file from a server device via a network, the manifest file including one or more media segment URLs and possibly one or more advertisement markers arranged in a predetermined sequence. In step 703, the handler determines whether any advertisement markers are included in the manifest file accessed in step 702. If yes (step 703, Y), then the flow proceeds to step 704; if no (step 703, N), then the flow proceeds to step 709.

In step 704, the handler transmits user preference information to an advertisement network server. In step 705, the handler determines whether a response including one or more advertisement URLs associated with user-customized advertisements has been received from the advertisement network server (within a predetermined time period after transmitting the user preference information to the advertisement network server, for example). If yes (step 705, Y), then the flow proceeds to step 707; if no (step 705, N), then the flow proceeds to step 706. In step 707, the handler receives a list including advertisement URL(s) corresponding to user-customized advertisement(s), and in step 708, the handler replaces the advertisement markers included in the manifest file with the advertisement URLs. On the other hand, in step 706, the handler removes (e.g., deletes) one or more advertisement markers from the manifest file. (The amount of advertisement markers removed may correspond to the number of ad URLs less than were expected that were received from the advertisement network server). The advertisement markers are deleted so that the video content wilt be played and the ads wilt be skipped (so as to not disrupt the user's viewing experience), since there is a delay in receiving the ad URLs from the network server. The flow then proceeds to step 709.

While various embodiments of this disclosure (e.g. the exemplary manifest file 300 in FIG. 3) include advertisement markers taking the exemplary form of “ADVERTISEMENT MARKER”, it should be understood that any form of marker or indicia (e.g. any character string, any alpha-numeric string, etc.) may be utilized to signify the position where user-customized advertisement URLs may be inserted into the manifest file. In various exemplary embodiments, the advertisement marker may take a form “#EXT- . . . ” similar to other elements (e.g. metadata) included in the user manifest file. Thus, even in a case where the manifest file is fed to another device (or media playback module) and the advertisement markers have not been replaced or removed, the other device may simply perform playback and ignore the advertisement markers. In this case, step 706 may be unnecessary, and the advertisement markers need not be removed when not used.

in step 709, the handler provides the manifest file to a media playback module. In step 710, the handler determines whether more media segments are expected to be added to the manifest file at the server side (for example, by determining that an end-transmission marker is not included in the manifest file). If yes (step 710, Y), then the flow proceeds to step 711; if no (step 710, N), then the flow ends at step 712. In step 711, the handler determines whether there is an indication that the playback mode is to be stopped (e.g. has the user indicated to the media playback module that they wish to stop watching the live content stream). If no (step 711, N), then the flow proceeds to step 713; if yes (step 711, Y), then the flow ends at step 712.

At step 713, the handler determines whether it is time to re-access the manifest file from the webserver. For example, the handler may determine that a predetermined time has elapsed since the manifest file was previously accessed from the web server. As another example, the handler may receive an indication from the media playback module that streaming content identified in the current manifest file has almost been played in its entirety, etc. When it is time to re-access the manifest file from the web server (step 713, Y), then the flow returns to step 702.

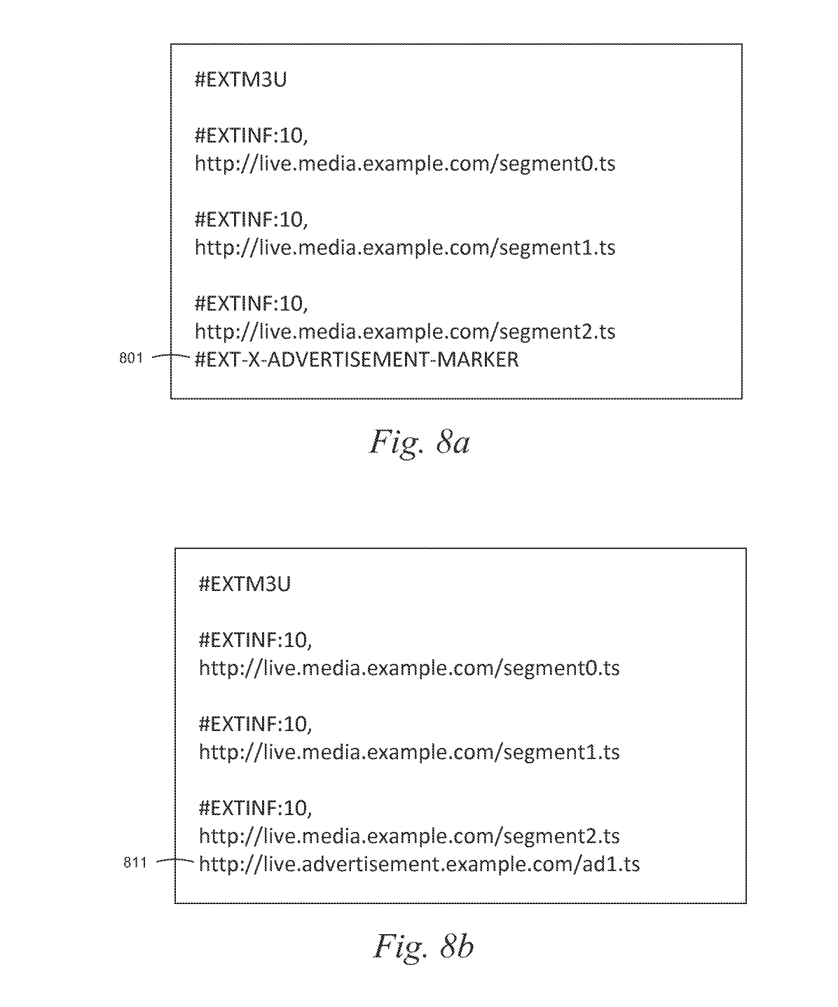

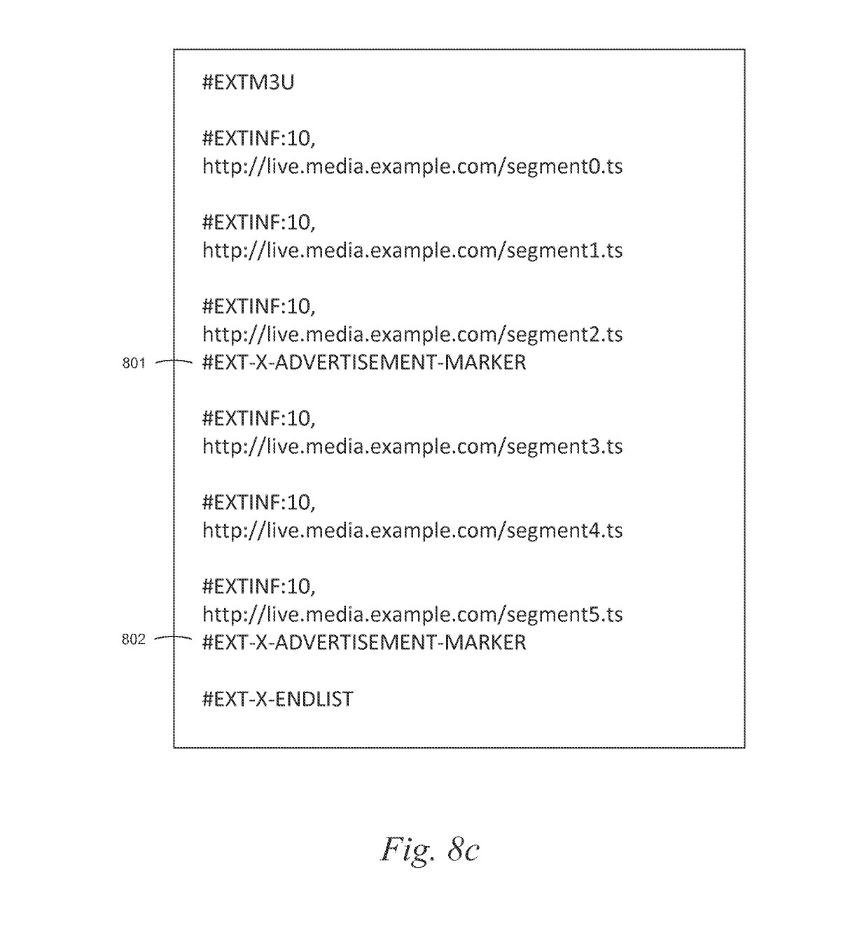

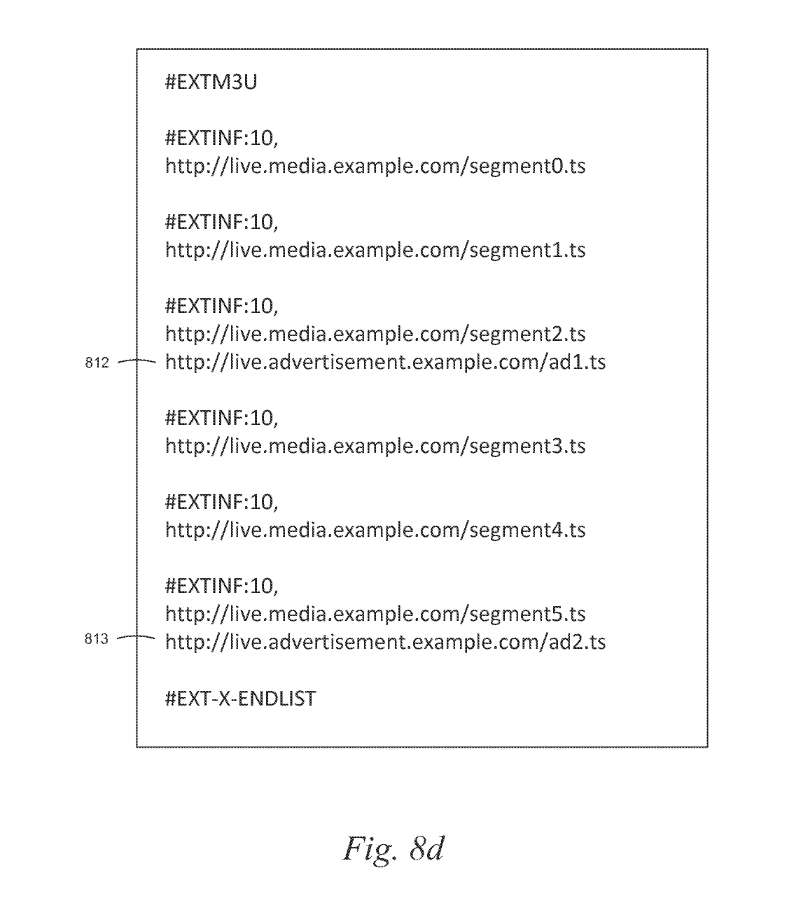

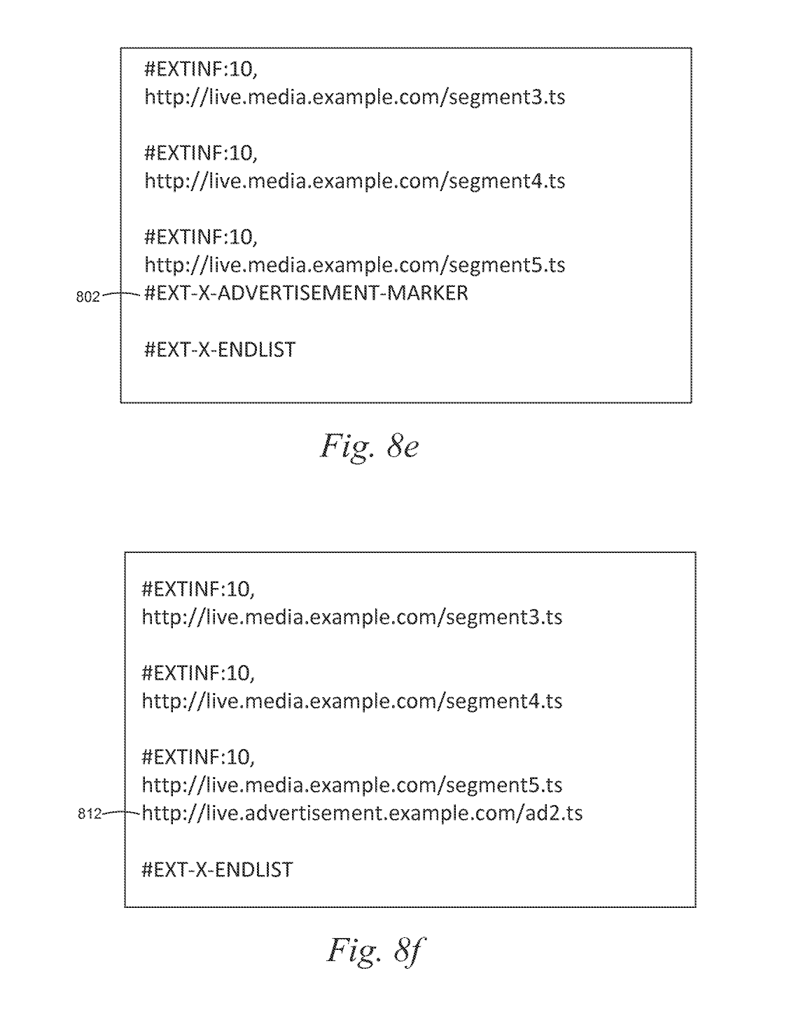

Note that in each successive iteration of the method of FIGS. 7a and 7b, the manifest file may include additional media segment URLs and possible additional advertisement markers. For example, FIG. 8a illustrates an example of a manifest file (including an advertisement marker 801) received at step 702 during iteration “i”, and FIG. 8b illustrates the same manifest file after the advertisement marker 801 has been replaced with an advertisement URL 811 in step 708, in iteration “i”. FIG. 5c illustrates an example of the manifest file (including advertisement marker 801 and an additional advertisement marker 802) received at step 702 during iteration “i+1”. As seen in FIG. 5c, the manifest files includes three new media segment URLs, and one new advertisement marker 802. FIG. 8d illustrates the same manifest file after the advertisement markers 802 and 803 have been replaced with advertisement URLs 812 and 813 in step 708, in iteration “i+1”.

Note that the manifest file received at step 702 in each successive iteration may include older media segments and advertisement markers that may have already been handled by the handler (and played by a media playback module) in a previous iteration of the method. This may be handled in a number of ways. According to one aspect, the handler may simply not address the issue and provide the manifest file (e.g. the manifest file in FIG. 8d) to the media playback module, and the media playback module may determine what media segment URLs or advertisements have already been played. Thus, the media playback module may ignore these previously identified media segments URLs and advertisement URLs.

According to another aspect, the handler itself may determine what media segment URLs and advertisement URLs have already been provided to the media playback module, and may delete these portions from the received manifest file at step 702. Thus, a truncated manifest file including the newly presented advertisement markers (and not the previously handled advertisement markers) is generated. For example, if the handler received the manifest file of FIG. 5c at step 702 (after the manifest file of FIG. 8a has already been previously received and handled), the handler may truncate the manifest file as seen in FIG. 8e (where the manifest file includes a newly presented advertisement marker 802 that has not yet been handled). Thereafter, steps 703 through 713 will be performed with respect to the truncated manifest file. For example, FIG. 8f illustrates the truncated manifest file of FIG. 5e after the advertisement marker 802 has been replaced with advertisement URL 812. In this way, the handler does not wait unnecessarily for advertisement URLs for advertisement markers that are no longer relevant (e.g. where the user has already viewed that portion of the manifest file).

According to various exemplary embodiments described below, the client device may stream video-on-demand (VOD) content as if it were live content, in order to incorporate late-bound user-customized advertisements into the VOD content stream as late as possible during playback of the VOD content stream.

For example, the manifest file may include a VOD marker, which may be inserted into the manifest file by the web server from which the manifest file is accessed (e.g. web server 120). The VOD marker may indicate that the video content associated with the manifest file corresponds to VOD content and not live content. As described above, with VOD content, the manifest file will generally already include all of the media segment URLs for the entire video. Thus, the VOD marker may indicate to a media playback module and/or client device that the manifest file already includes all of the media segment files, and need only be accessed once from the web server.

According to various exemplary embodiments, after the manifest handler module 200a receives the manifest file from a web server (e.g. web server 120), the manifest handler module parses through the manifest file, detects the presence of the VOD marker, and marks the manifest file as live (e.g., the manifest handler module may modify the VOD marker into a live marker, or replace the VOD marker with a live marker, etc). The live marker may indicate that the video content associated with the manifest file corresponds to live content. As described above, with Live content, the manifest file will generally not include all of the media segment URLs for the entire video. Thus, the live marker may indicate to a media playback module and/or client device that the manifest file is continuously being updated with new media segment files, and needs to be accessed repeatedly from the web server. The VOD marker or live marker may be any form of marker or indicia (e.g. any character string, any alpha-numeric string, etc.).

Alternatively, the web server (e.g. web server 120) may mark the manifest file as live, and include a signal (e.g. metadata or marker in the manifest file) indicating that the manifest file is actually associated with VOD content. In this way, the handler detects that the manifest file is actually associated with VOD content.

In this way, the client device may access the manifest file for the VOD content repeatedly, as if it were a manifest file for live content that is continually being updated at the web server side, except that the manifest file for the VOD content is not actually being updated at the server-side (i.e. all the media segment URLs and advertisement markers are already in place the first time the manifest file is accessed). By causing the media playback module to access the manifest file repeatedly, the process of FIG. 6 may be repeated periodically, such that advertisement URLs are continuously being received and incorporated to the manifest file. Thus, since the customized ads to be interleaved into portions of VOD content are obtained just before the corresponding portions are played, the ads are customized for the user as late as possible during playback. Thus, the ads are better customized for the user, since they are selected based on the most recent information regarding user preferences, device geo-location, advertisement playback history, advertising targets, etc.

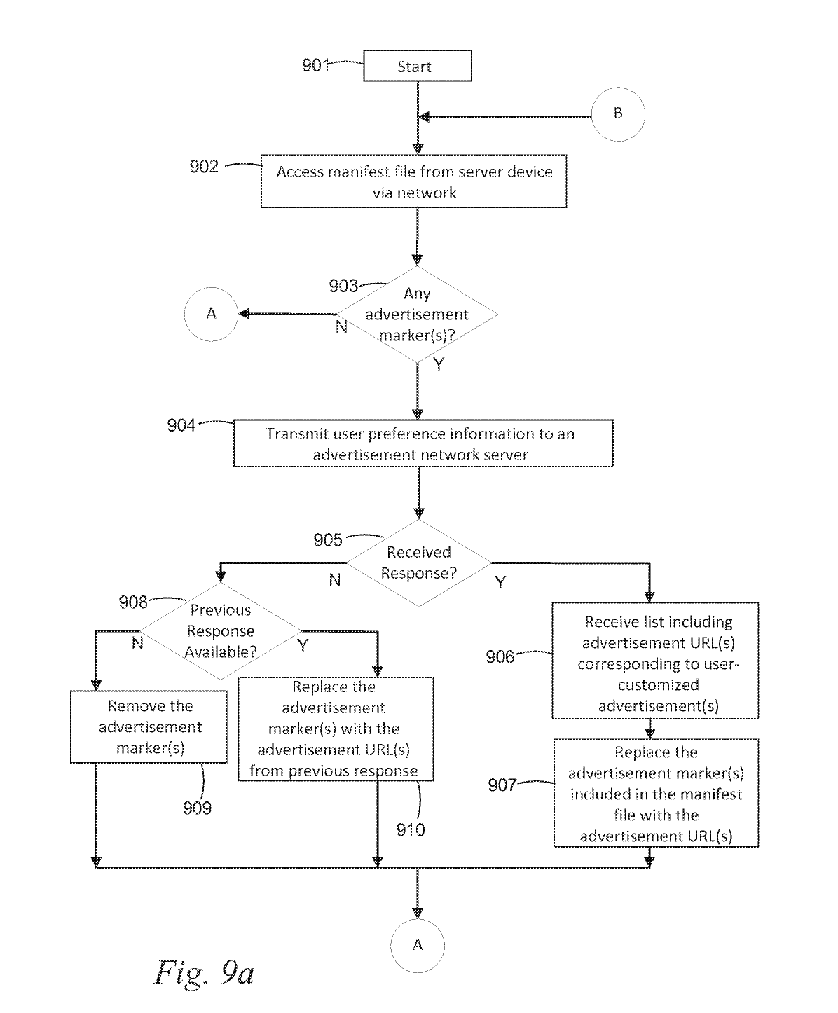

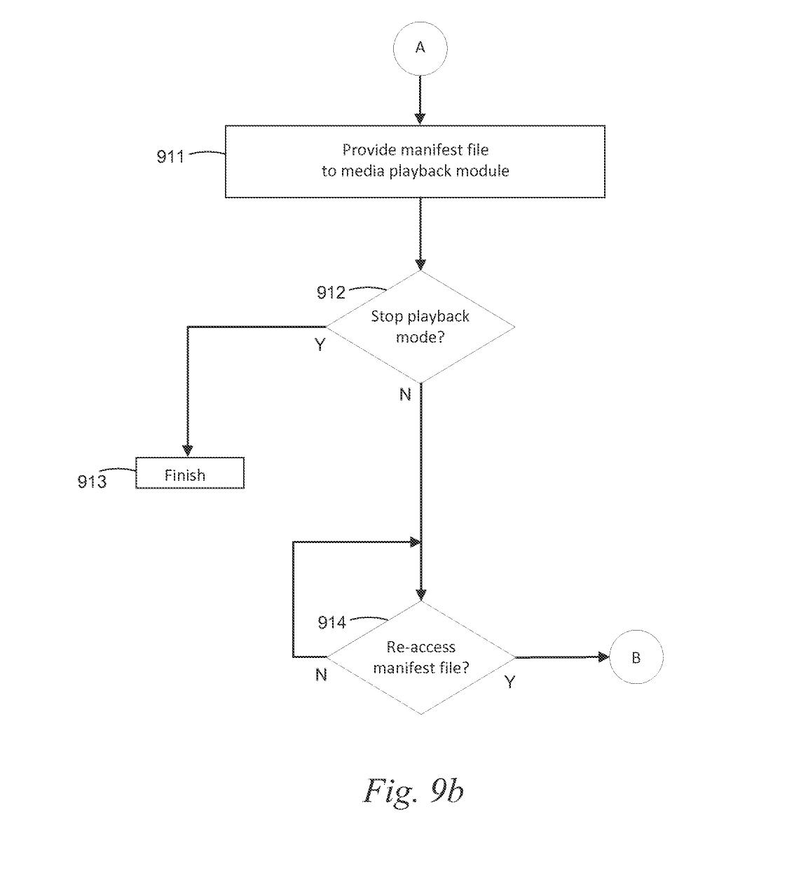

In FIGS. 9a and 9b, there is illustrated an exemplary method of streaming live video content, performed by a client device, in accordance with various exemplary embodiments. The method of FIGS. 9a and 9b may be performed, for example, by an application handler (such as manifest handler module 200a illustrated in FIG. 2) and/or a media playback module (such as media playback module 200b illustrated in FIG. 2).

The method starts in step 901, and in step 902, the handler accesses a manifest file from a server device via a network, the manifest file including one or more media segment URLs and possibly one or more advertisement markers arranged in a predetermined sequence. Moreover, in step 902, the manifest handler module 200a may parse through the manifest file, detect the presence of a VOD marker, and mark the manifest file as live (e.g., modify the VOD marker into a live marker, or replace the VOD marker with a live marker, etc). The live marker may indicate that the video content associated with the manifest file corresponds to live content. In step 903, the handler determines whether any advertisement markers are included in the manifest file accessed in step 902. If yes (step 903, Y), then the flow proceeds to step 904; if no (step 903, N), then the flow proceeds to step 911.

In step 904, the handler transmits user preference information to an advertisement network server. In step 905, the handler determines whether a response including one or more advertisement URLs associated with user-customized advertisements has been received from the advertisement network server (within a predetermined time period after transmitting the user preference information to the advertisement network server, for example). If yes (step 905, Y), then the flow proceeds to step 906; if no (step 905, N), then the flow proceeds to step 908. In step 906, the handler receives a list including advertisement URL(s) corresponding to user-customized advertisement(s), and in step 907, the handler replaces the advertisement markers included in the manifest file with the received advertisement URLs. On the other hand, in step 908, the handler determines whether previous advertisement URLs were inserted into a corresponding advertisement marker in a manifest file during a previous iteration. (step 908, Y), then the flow proceeds to step 910, where the advertisement markers in the current manifest file are replaced with previous advertisement URLs received from a previous iteration; if no (step 908, N), then the flow proceeds to step 909, where the handler removes (e.g. deletes) one or more advertisement markers from the manifest file. (The amount of advertisement markers removed may correspond to the number of ad URLs less than were expected that were received from the advertisement network server). The advertisement markers are deleted so that the video content will be played and the ads will be skipped (so as to not disrupt the user's viewing experience), since there is a delay in receiving the ad URLs from the network server. The flow then proceeds to step 911.

While various embodiments of this disclosure (e.g. the exemplary manifest file 300 in FIG. 3) include advertisement markers taking the exemplary form of “ADVERTISEMENT MARKER”, it should be understood that any form of marker or indicia (e.g. any character string, any alpha-numeric string, etc.) may be utilized to signify the position where user-customized advertisement URLs may be inserted into the manifest file. In various exemplary embodiments, the advertisement marker may take a form “#EXT- . . . ” similar to other elements (e.g. metadata) included in the user manifest file. Thus, even in a case where the manifest file is fed to another device (or media playback module) and the advertisement markers have not been replaced or removed, the other device may simply perform playback and ignore the advertisement markers. In this case, step 909 may be unnecessary, and the advertisement markers need not be removed when not used.

In step 911, the handler provides the manifest file to a media playback module and/or a client device. In step 912, the handler determines whether there is an indication that the playback mode is to be stopped (e.g. has the user indicated to the media playback module and/or client device that they wish to stop watching the live content stream). If no (step 912, N), then the flow proceeds to step 914; if yes (step 912, Y), then the flow ends at step 913.

At step 914, the handler and/or media playback module determines whether the manifest file is to be re-accessed from the web server. For example, if the manifest file includes the live marker described above, the handler and/or media playback module may determine that the manifest file is to be re-accessed (e.g. after a predetermined time has elapsed since the manifest file was previously accessed from the web server). If the handler and/or media playback module determines that the manifest file is to be re-accessed from the web server (step 914, Y), then the flow returns to step 902.

While the same manifest file is being accessed at step 902 in each iteration of the method, during successive iterations more and more of the media segments and/or advertisement markers included in the manifest file will have been handled by the handler (and played by a media playback module) in a previous iteration of the method. This may be handled in a number of ways. According to one aspect, the handler may simply not address the issue and provide the manifest file (e.g. the manifest file in FIG. 8d) to the media playback module, and the media playback module may determine what media segment URLs or advertisements have already been played. Thus, the media playback module may ignore these previously identified media segments URLs and advertisement URLs.

According to another aspect, the handler itself may determine what media segment URLs and advertisement URLs have already been provided to the media playback module, and may delete these portions from the received manifest file at step 902. For example, if the handler received the manifest file of FIG. 8c at step 902, and it is determined that the first three media segment files and the first advertisement marker 801 have already been handled and played back, the handler may truncate the manifest file as seen in FIG. 8e, where the manifest file now includes one advertisement marker 802 that has not yet been handled. Thereafter, steps 903 through 914 will be performed with respect to the truncated manifest file. For example, FIG. 8f illustrates the truncated manifest file of FIG. 80 after the advertisement marker 802 has been replaced with advertisement URL 812. In this way, the handler does not wait for advertisement URLs for advertisement markers that are no longer relevant (since the user has already viewed that portion of the manifest file).

According to various exemplary embodiments described below, the client device may access the manifest file for the VOD content once, and break the manifest file into portions. The handler may perform various operations (including obtaining user-customized advertisements) on one portion at a time, before transmitting the portion to the media playback module 200b for playback, and then repeating the process for the following portions.

Thus, since the customized ads to be interleaved into the portions of VOD content are obtained just before the corresponding portions are played, the ads are customized for the user as late as possible during playback. Thus, the ads are better customized for the user, since they selected based on the most recent information regarding user preferences, device geo-location, advertisement playback history, advertising targets, etc.

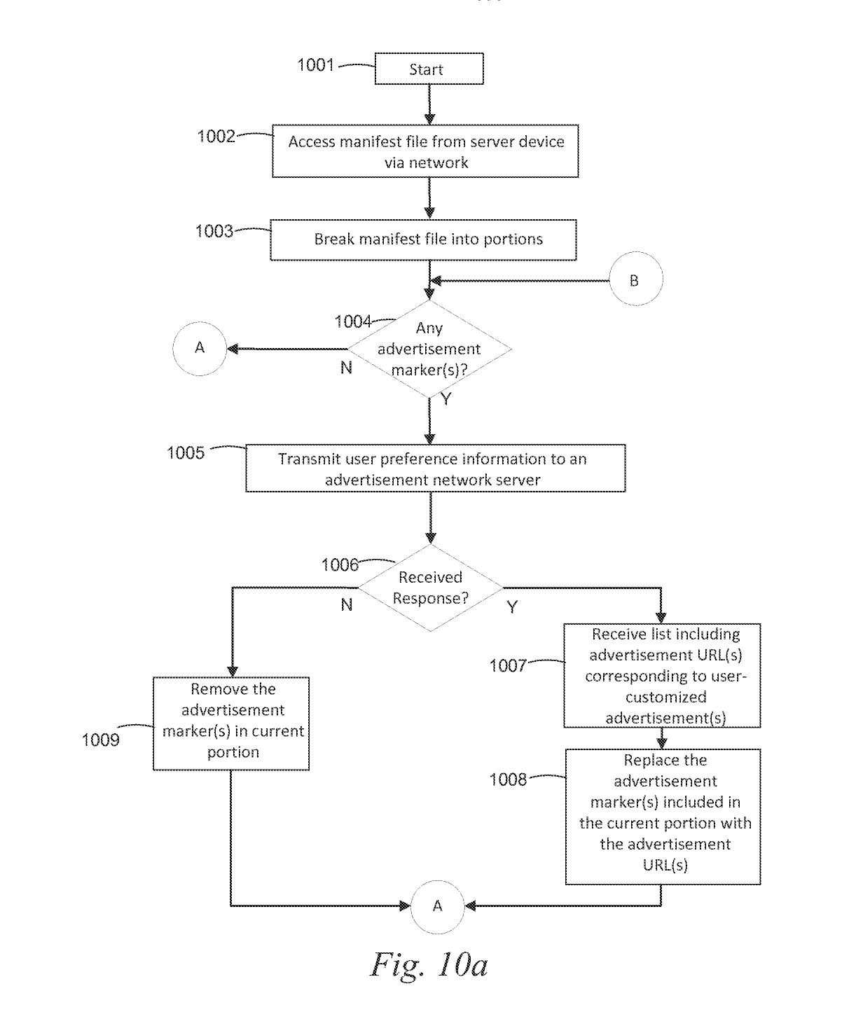

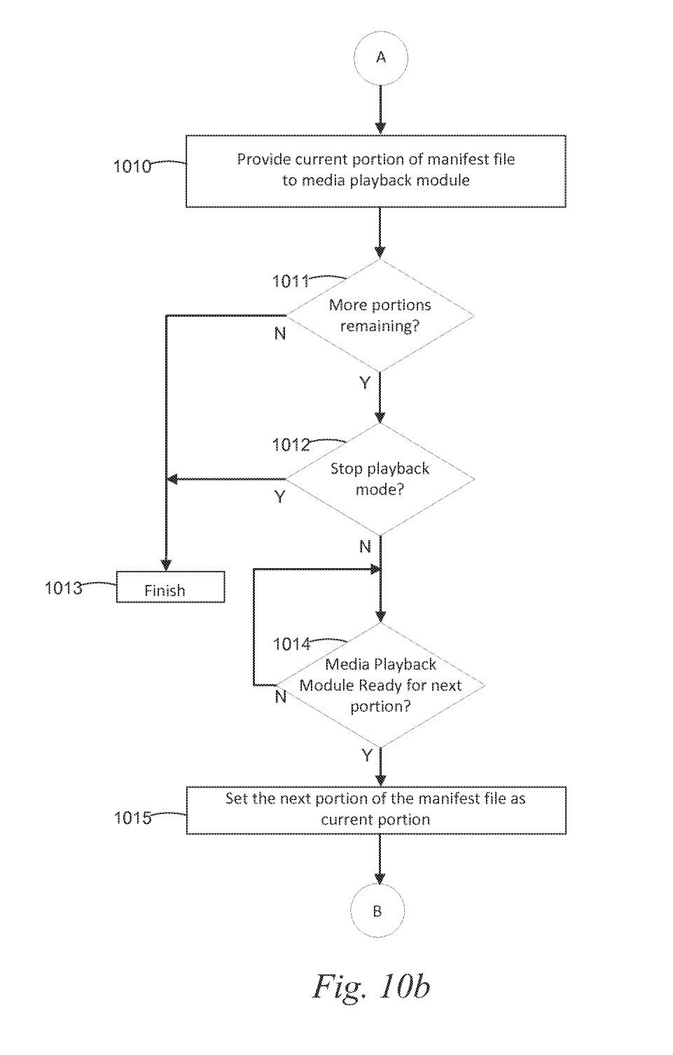

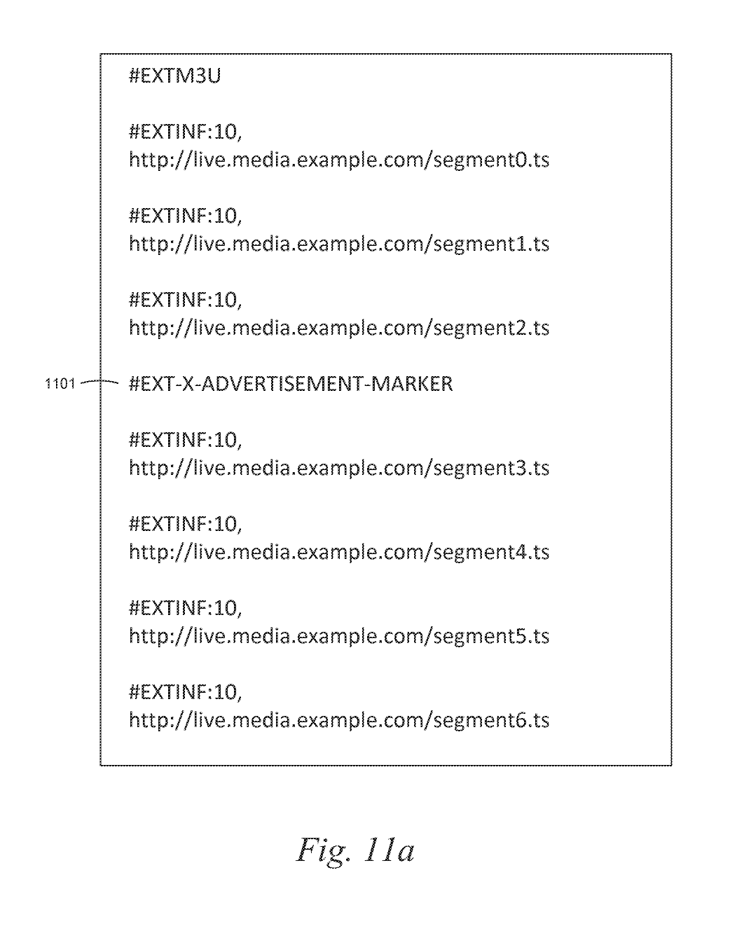

In FIGS. 10a and 10b, there is illustrated an exemplary method of streaming VOD content, performed by a client device, in accordance with various exemplary embodiments. The method of FIGS. 10a and 10b may be performed, for example, by an application handler (such as manifest handler module 200a illustrated in FIG. 2).

The method starts in step 1001, and in step 1002, the handler accesses a manifest file from a server device via a network, the manifest file including one or more media segment URLs and possibly one or more advertisement markers arranged in a predetermined sequence. In step 1003, the handler breaks the manifest file into portions (e.g. into numerous portions having an equal number of media segment files, or having an equal number of advertisements, or having an equal video playback length, etc.). After step 1003, the handler sets the first portion of the manifest file as a “current portion” for the purposes of the remaining operations of the method. In step 1004, the handler determines whether any advertisement markers are included in the current portion of the manifest file. If yes (step 1004, Y), then the flow proceeds to step 1005; if no (step 1004, N), then the flow proceeds to step 1010.

In step 1005, the handler transmits user preference information to an advertisement network server. In step 1006, the handler determines whether a response including one or more advertisement URLs associated with user-customized advertisements has been received from the advertisement network server (within a predetermined time period after transmitting the user preference information to the advertisement network server, for example). If yes (step 1006, Y), then the flow proceeds to step 1007; if no (step 1006, N), then the flow proceeds to step 1009. In step 1007, the handler receives a list including advertisement URL(s) corresponding to user-customized advertisement(s), and in step 1008, the handler replaces the advertisement markers included in the current portion of the manifest file with the advertisement URLs. On the other hand, in step 1009, the handler removes (e.g. deletes) one or more advertisement markers from the manifest file. (The amount of advertisement markers removed may correspond to the number of ad URLs less than were expected that were received from the advertisement network server). The advertisement markers are deleted so that the video content will be played and the ads will be skipped (so as to not disrupt the user's viewing experience), since there is a delay in receiving the ad URLs from the network server. The flow then proceeds to step 1010.

While various embodiments of this disclosure (e.g. the exemplary manifest file 300 in FIG. 3) include advertisement markers taking the exemplary form of “ADVERTISEMENT MARKER”, it should be understood that any form of marker or indicia e.g. any character string, any alpha-numeric string, etc.) may be utilized to signify the position where user-customized advertisement URLs may be inserted into the manifest file. In various exemplary embodiments, the advertisement marker may take a form “#EXT- . . . ” similar to other elements (e.g. metadata) included in the user manifest file. Thus, even in a case where the manifest file is fed to another device (or media playback module) and the advertisement markers have not been replaced or removed, the other device may simply perform playback and ignore the advertisement markers. In this case, step 1009 may be unnecessary, and the advertisement markers need not be removed when not used.

In step 1010, the handler provides the current portion of the manifest file to a media playback module and/or client device. In step 1011, the handler determines whether more portions of the manifest file (after the current portion) remain to be handled. If yes (step 1011, Y), then the flow proceeds to step 1012; if no (step 1011, N), then the flow ends at step 1013. In step 1012, the handler determines whether there is an indication that the playback mode is to be stopped (e.g. has the user indicated to the media playback module and/or client device that they wish to stop watching the live content stream). If no (step 1012, N), then the flow proceeds to step 1014; if yes (step 1012, Y), then the flow ends at step 1013.

At step 1014, the handler determines whether the media playback module is ready to receive the next portion of the manifest file. For example, the handler may determine that a predetermined time has elapsed since the current portion of the manifest file was provided to the media playback module. As another example, the handler may receive an indication from the media playback module that streaming content identified in the current portion of the manifest file has almost been played in its entirety, etc. When it is determined that the media playback module is ready for the next portion (step 1014, Y), then the handler sets the next portion of the manifest file as the current portion in step 1015, and then the flow returns to step 1004.

According to various exemplary embodiments, if the user rewinds and replays previous viewed portions of video content, the manifest handler module may ensure that the user is not presented with any advertisements. Alternatively, if the user rewinds and replays previous viewed portions of video content, the manifest handler module may ensure that the user is not presented with the same advertisements that were presented during the previous portions of the video content. For example, the manifest handler module may maintain a history of advertisement URLs and/or associated advertisements that have been played back (as well as the corresponding portions of the video content stream at which the advertisement were played). If a previously viewed portion of the video content is played back, the handler module obtains advertisements URLs from the advertisement networks servers as described herein, and compares the newly received advertisements with those in the history. If there is a match, then the handler module attempts to obtain different advertisements from the advertisement network servers. These aspects may be applied not only to the playback of previously viewed portions of video content, but also throughout the entire streaming process, in order to ensure is not presented with the same advertisements twice or more than a predetermined number of times).

According to another aspect, the manifest handler module 200a of the client device 200 is configured to replace one or more media segment URLs the manifest file with one or more advertisement URLs representing user-customized advertisements.

For example, during playback of live content, when advertisement URLs are inserted into advertisement markers in the manifest file (as described in various embodiments above), this may effectively “delay” the playback of the live content that corresponds to the various media segments URLs that follow the inserted advertisement URL. For example, if a viewer is watching a live event program based on the playback of media segment files, and an advertisement URL corresponding to a 30 second advertisement is inserted, then upon the resuming playback of the live event program (i.e. playback of the media segment URLs immediately following the playback of the inserted advertisement URL), the video of the live event program would be effectively delayed by 30 seconds relative to real time. Accordingly, over the course of a 1.5 hour live event program, if 20 advertisement insertion events occurred, each roughly 30 seconds, then by the end of the event the user would be still watching the “live event”, when in reality the event ended approximately 10 minutes ago. Thus, for a live programming scenario, the insertion of advertisements may cause a delay in the programming as additional advertisements are inserted and viewed.

Accordingly this exemplary embodiment, the manifest file includes media segment URLs and advertisement markers arranged in a predetermined sequence, and the advertisement markers signify the location where the advertisements URLs are to be inserted (i.e. where the advertisements are to start playback), similar to the various embodiments described above. However, the manifest handler module 200a may also replace the main content segments (i.e. media segment URLs) with the inserted advertisement URLs.

According to this exemplary embodiment, when the manifest handler module 200a receives a manifest file, the manifest handler module inspects the manifest file and detects one or more advertisement markers. The manifest handler module then determines the duration of the advertisements to be inserted at the position of the advertisement URLs. For example, a web server (e.g. web server 120, from which the manifest file was accessed) may include advertisement duration information within the manifest file, wherein the advertisement duration information may be associated with one or more advertisement markers in the manifest file and indicate the duration of the corresponding advertisements to be inserted at the advertisement markers. The advertisement duration information may be included in the actual advertisement marker, or may be included adjacent to the advertisements marker (e.g. as metadata enclosed in “#” tags adjacent to metadata corresponding to the advertisement markers). Alternatively, when the manifest handler module 200a communicates with advertisement network server 140 and receives advertisement URLs from the advertisement network server 140, the manifest handler module 200a may also receive, from the advertisement network server 140, advertisement duration information associated with user-customized advertisements corresponding to the received advertisement URLs.

After the manifest handler module 200a determines the duration of the advertisements to be inserted, the manifest handler module may remove a certain number of media segment URLs from the manifest file that correspond to the duration of the advertisements to be inserted. Thus, the manifest handler module 200a effectively replaces media segment URLs with advertisement URLs. The manifest handler module 200a may, for example, determine the length of each of the media segments corresponding to the media segment URLs, based on metadata included in the manifest file that is associated with the media segment URLs.

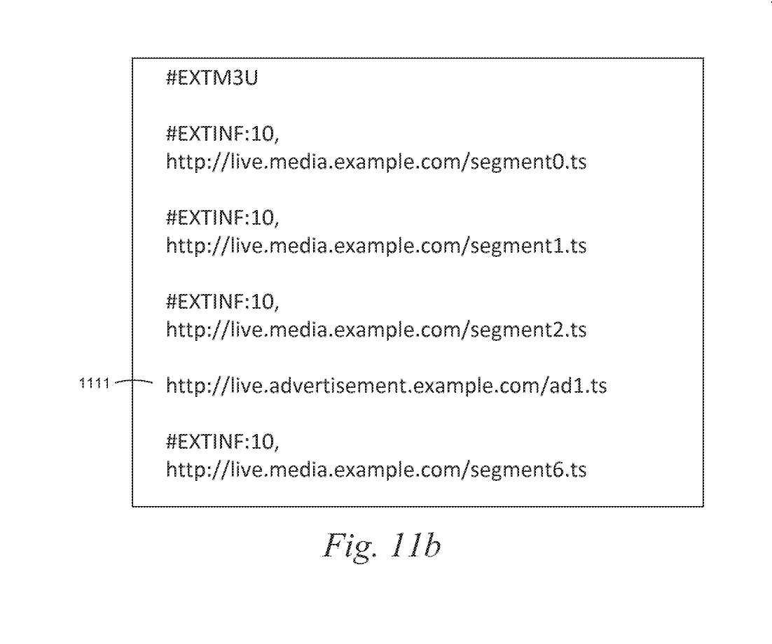

FIG. 11a illustrates an example of a manifest file received by the manifest handler module 200a, wherein the manifest file includes an advertisement marker 1101. If the manifest handler module determines that advertisement duration information (not shown in FIG. 11a) indicates that a 30 second advertisement is to be inserted at advertisement marker 1101, and manifest handler module determines that each media segment URL represents a media segment of 10 seconds, then the manifest handler module may insert the advertisement URL for the 30 second advertisement at the advertisement marker, and remove the following three media segment URLs (corresponding to 30 seconds worth of media content). FIG. 11b illustrates the manifest file of FIG. 11a after the advertisement URL 1111 has been inserted at the advertisement marker 1101, and the advertisement marker 1101 and the three media segment URLs following advertisement maker 1101 have been removed/replaced.

The manifest handler module 200a may replace the media segment URLs with advertisement URLs, as described in this embodiment, after determining that the manifest file represents live content (e.g. by identifying live content marker included in the manifest file). The aspects of this embodiment are not limited to live content and may also be applied to VOID content (e.g. after the manifest handler module 200a identifies a VOD content marker included in the manifest file).

According to this exemplary embodiment, a set of sequence numbers for each of the media segments and advertisement segments in a manifest file may be maintained and modified depending upon whether the number of advertisement segments being inserted is greater or lesser than the main content replaced. In addition, since the duration of an advertisement may not exactly match a set of media content segments to be replaced, a threshold may be used to fine tune the insertion/replacement process. For example, it may be determined that if an advertisement for insertion would overlap a media segment by less than a predetermined threshold, then the advertisement will not be inserted and the media content segments will not be replaced, or alternatively a different advertisement should be inserted, or alternatively the inserted advertisement should be truncated so as not to overlap the relevant media segment. For instance, suppose a 21 second advertisement is to be inserted, and each of the media segments have a duration of 10 seconds. If the 21 second advertisement were to replace three media segment, then the 21 second advertisement would overlap the third media segment by only 1 second. Thus, removing the three media segments would cause a 9 second gap in the playback after the advertisement ends. Thus, the threshold may correspond to a duration (e.g. 5 seconds), and it may be determined that if an advertisement for insertion would overlap a media segment by less than a predetermined threshold, then advertisement will not be inserted and the media content segments will not be replaced, or alternatively a different advertisement will be inserted, or alternatively the inserted advertisement will be truncated so as not to overlap the relevant media segment (and the relevant media segment will still be played).

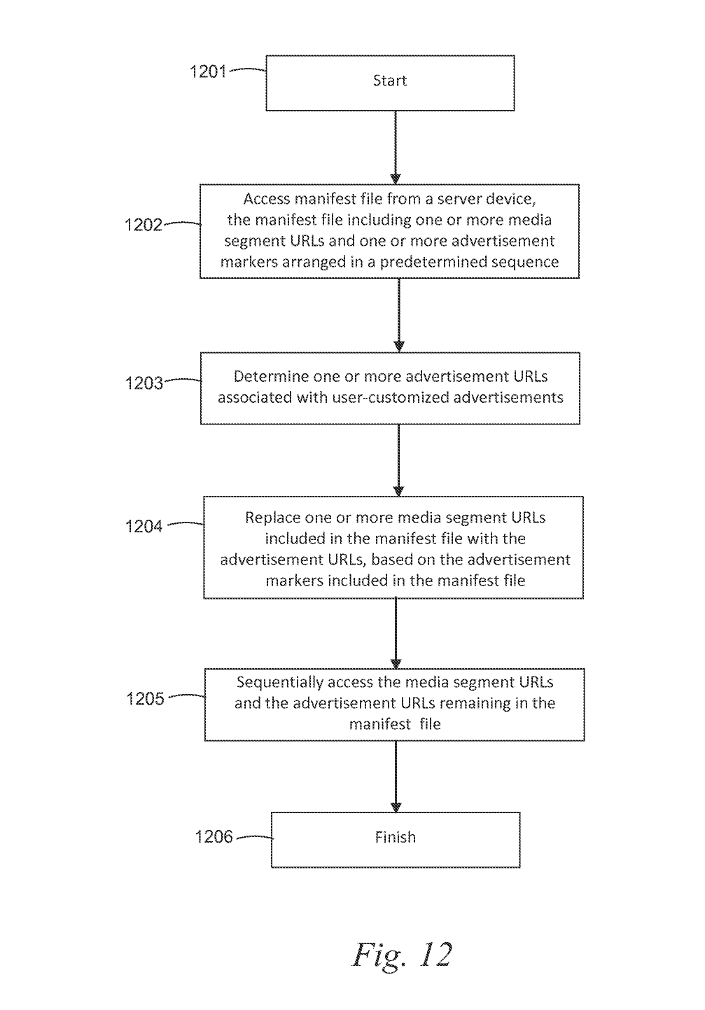

In FIG. 12, there is illustrated an exemplary method performed by a client device, in accordance with various exemplary embodiments. For example, the method of FIG. 12 may be performed by the manifest handler module 200a illustrated in FIG. 2.

The method starts in step 1201, and in step 1202, the media handler module accesses a manifest file from a server device, the manifest file including one or more media segment URLs and one or more advertisement markers arranged in a predetermined sequence. In step 1203, the media handler module determines one or more advertisement URLs associated with user-customized advertisements. In step 1204, the media handler module replaces one or more media segment URLs included in the manifest file with the advertisement URLs, based on the advertisement markers included in the manifest file. In step 1205, the media handler module sequentially accesses the media segment URLs and the advertisement URLs remaining in the manifest file. The method finishes at step 1206.

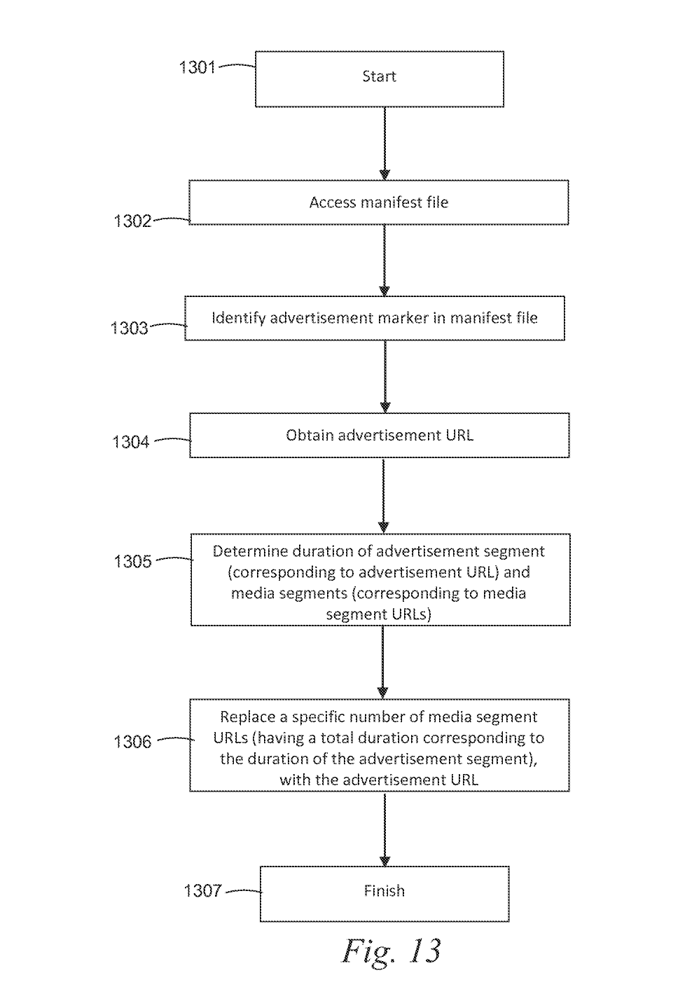

In FIG. 13, there is illustrated an exemplary method performed by a client device, in accordance with various exemplary embodiments. For example, the method of FIG. 13 may be performed by the manifest handler module 200a illustrated in FIG. 2.

The method starts in step 1301, and in step 1302, the media handier module accesses a manifest file from a server device. The manifest file may include one or more media segment URLs and one or more advertisement markers arranged in a predetermined sequence. In step 1303, the media handler module identifies an advertisement marker in the manifest file. In step 1304, the media handler module obtains an advertisement URL. In step 1305, the media handler module determines the duration of an advertisement segment (corresponding to the advertisement URL) and the duration of media segments (corresponding to the media segment URLs the manifest file). In step 1306, the media handler module replaces a specific number of the media segment URLs (associated with media segments having a total duration corresponding to the duration of the advertisement segment), with the advertisement URL associated with the advertisement segment.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures may require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

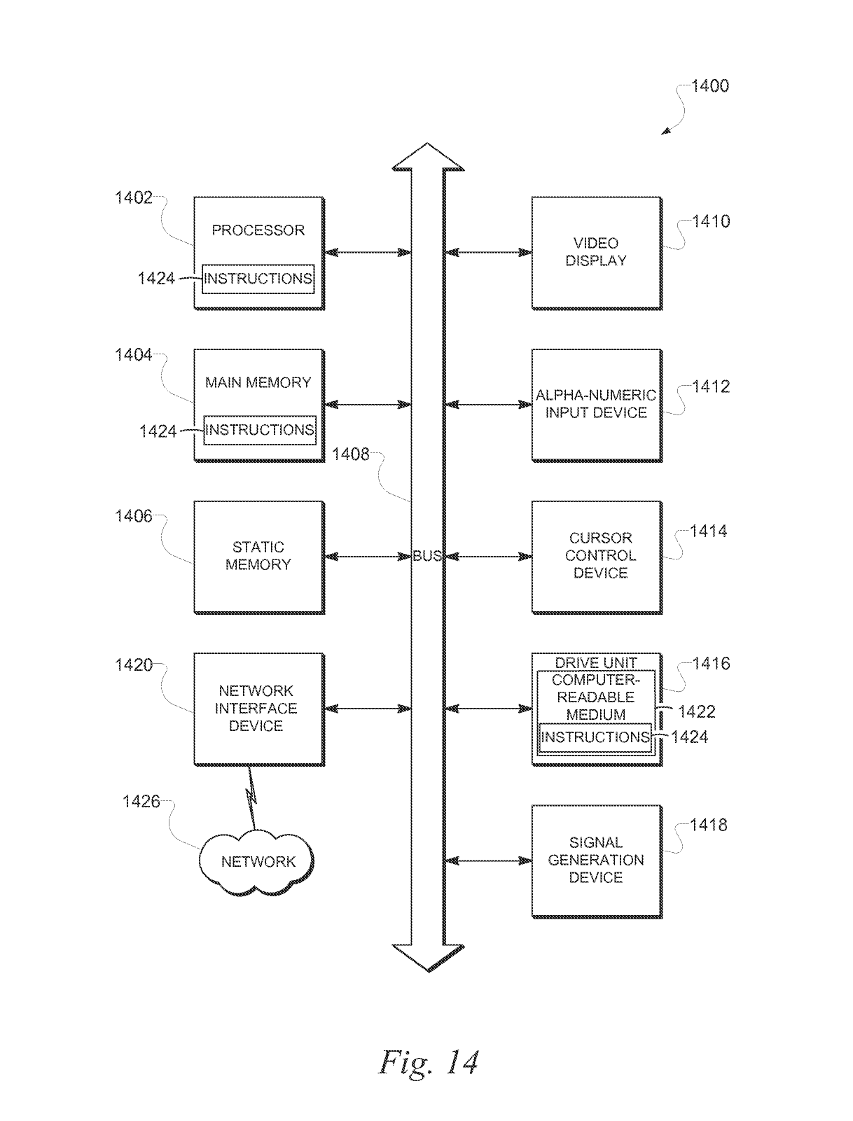

FIG. 14 is a block diagram of machine in the example form of a computer system 1400 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1400 includes a processor 1402 (e.g., a central processing unit (CPU), a graphics processing unit (GPU) or both), a main memory 1404 and a static memory 1406, which communicate with each other via a bus 1408. The computer system 1400 may further include a video display unit 1410 (e.g., a liquid crystal display (LCD) or a cathode ray tube (CRT)). The computer system 1400 also includes an alphanumeric input device 1412 (e.g., a keyboard or a touch-sensitive display screen), a user interface (UI) navigation device 1414 (e.g., a mouse), a disk drive unit 1416, a signal generation device 1418 (e.g., a speaker) and a network interface device 1420.

### Machine-Readable Medium

The disk drive unit 1416 includes a machine-readable medium 1422 on which is stored one or more sets of instructions and data structures (e.g., software) 1424 embodying or utilized by any one or more of the methodologies or functions described herein. The instructions 1424 may also reside, completely or at least partially, within the main memory 1404 and/or within the processor 1402 during execution thereof by the computer system 1400, the main memory 1404 and the processor 1402 also constituting machine-readable media.

While the machine-readable medium 1422 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1424 may further be transmitted or received over a communications network 1426 using a transmission medium. The instructions 1424 may be transmitted using the network interface device 1420 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method comprising:
downloading, with a processor of a client device, a manifest file from a server device to the client device via a network, the manifest file including one or more media segment reference links and one or more advertisement markers arranged in a predetermined sequence;
obtaining, with the processor of the client device, one or more advertisement reference links associated with user-customized advertisements, based on user preference information stored at the client device;
replacing, with the processor of the client device, the advertisement markers included in the manifest file with the advertisement reference links; and
executing, with the processor of the client device, the manifest file by sequentially accessing the media segment reference links and the advertisement reference links included in the manifest file in accordance with the predetermined sequence.

2. The method of claim 1, wherein the obtaining comprises:
transmitting the user preference information to an advertisement network server; and
receiving the one or more advertisement reference links corresponding to the user-customized advertisements from the advertisement network server.

3. The method of claim 1, further comprising:
accessing, with the processor of the client device, the manifest file from the server device at predetermined time intervals; and
obtaining, with the processor of the client device, additional advertisement reference links to replace new advertisement markers in a most recently accessed manifest file.

4. The method of claim 3, further comprising:
determining, with the processor of the client device, that one or more of the additional advertisement reference links have not been obtained within a predetermined time period; and
removing, with the processor of the client device, one or more of the new advertisement markers from the manifest file.

5. The method of claim 1, further comprising:
determining, with the processor of the client device, that the manifest file includes a video-on-demand (VOD) content marker; and
replacing, with the processor of the client device, the VOD content marker in the manifest file with a live content marker.

6. The method of claim 5, further comprising:
accessing, with the processor of the client device, the manifest file from the server device at predetermined time intervals, based on the live content marker; and
obtaining, with the processor of the client device, additional advertisement reference links to replace the advertisement markers in the manifest file.

7. The method of claim 6, further comprising:
determining, with the processor of the client device, that one or more of the additional advertisement reference links have not been obtained within a predetermined time period; and
replacing, with the processor of the client device, the advertisement markers in the manifest file with previously obtained advertisement reference links.

8. The method of claim 1, wherein the advertisement markers are located within metadata portions of the manifest file associated with specific ones of the media segment reference links.

9. The method of claim 1, wherein the user preference information includes client device geo-location information.

10. The method of claim 1, wherein the user preference information includes advertisement playback history information.

11. A
manifest handler module, executable by a processor, configured to
download a manifest file from a server device, to a client device, via a network, the manifest file including one or more media segment reference links and one or more advertisement markers arranged in a predetermined sequence;
obtain, at the client device, one or more advertisement reference links associated with user-customized advertisements, based on user preference information stored at the client device; and
replace, at the client device, the advertisement markers included in the manifest file with the advertisement reference links; and
a media playback module configured to
execute, at the client device, the manifest file by sequentially access the media segment reference links and the advertisement reference links included in the manifest file in accordance with the predetermined sequence.

12. The device of claim 11, wherein the processor is further configured by the manifest handler module to:
transmit the user preference information to an advertisement network server; and
receive the one or more advertisement reference links corresponding to the user-customized advertisements from the advertisement network server.

13. The device of claim 11, wherein the manifest handler module corresponds to a specialized handler function of a URL-type application defined protocol, and
the manifest handler module is triggered when the media playback module transmits a request for the manifest file to a modified URL, the modified URL being a URL associated with the manifest file that has been modified based on the URL-type application defined protocol.

14. The device of claim 13, wherein when the media playback module transmits the request for the manifest file to the modified URL, the manifest handler module intercepts the request, and transmits a second request for the manifest file to the server device.

15. The device of claim 11, wherein the processor is further configured by the manifest handler module to:
determine that the manifest file includes a video-on-demand (VOD) content marker; and
replace the VOD content marker in the manifest file with a live content marker.

16. The device of claim 15, wherein the processor is further configured by the manifest handler module to:
access the manifest file from the server device at predetermined time intervals, based on the live content marker; and
obtain additional advertisement reference links to replace the advertisement markers in the manifest file.

17. The device of claim 16, wherein the processor is further configured by the manifest handler module to:
determine that one or more of the additional advertisement reference links have not been obtained within a predetermined time period; and
replace the advertisement markers in the manifest file with previously obtained advertisement reference links.

18. The device of claim 11, wherein the advertisement markers are located within metadata portions of the manifest file associated with specific ones of the media segment reference links.

19. The device of claim 11, wherein the user preference information includes client device geo-location information.

20. A non-transitory computer-readable storage medium containing executable instructions stored thereon that, when executed by one or more processors of a client device, cause the machine to perform operations comprising:
downloading a manifest file from a server device via a network, the manifest file including one or more media segment reference links and one or more advertisement markers arranged in a predetermined sequence;
obtaining one or more advertisement reference links associated with user-customized advertisements, based on user preference information stored at a client device;
replacing the advertisement markers included in the manifest file with the advertisement reference links; and
executing, with the processor of the client device, the manifest file by sequentially accessing the media segment reference links and the advertisement reference links included in the manifest file in accordance with the predetermined sequence.
